(19) United States
(12) Patent Application Publication
(10) Pub. No.: US 2025/0106658 A1
(43) Pub. Date: Mar. 27, 2025

(54) PERFORMANCE MONITORING AND REPORTING TO SUPPORT AIML OPERATION

(71) Applicant: InterDigital Patent Holdings, Inc., Wilmington, DE (US)

(72) Inventors: Ulises Olvera-Hernandez, Saint-Lazare (CA); Xiaoyan Shi, Lake Oswego, OR (US); Alec Brusilovsky, Downingtown, PA (US); Achref Methenni, Montreal (CA); Michael Starsinic, Newtown, PA (US); Zhibi Wang, Woodridge, IL (US); Morteza Kheirkhah, London (GB)

(73) Assignee: InterDigital Patent Holdings, Inc., Wilmington, DE (US)

(21) Appl. No.: 18/833,714

(22) PCT Filed: Jan. 27, 2023
(86) PCT No.: PCT/US2023/011713

§ 371 Date: Jul. 26, 2024

Related U.S. Application Data
(60) Provisional application No. 63/303,758, filed on Jan. 27, 2022.

(51) Int. Cl. H04W 24/08; H04L 41/16; H04W 24/02

(52) U.S. Cl. CPC H04W 24/08; H04L 41/16; H04W 24/02

(57) ABSTRACT

A WTRU may send a registration message to a first network node. The registration message may indicate a capability to perform a network performance prediction and may comprise information indicating AI operation types. The first network node which may determine whether the WTRU is permitted to request network performance prediction information. If the WTRU is permitted, the WTRU may send a packet data unit (PDU) session message that indicates a request to subscribe to network analytics associated with the AI operation types. A second network node may receive the PDU session message and may send a subscription message to a third network node. The subscription message may comprise, for example, the AI operation types. The second network node may receive a notification message that indicates information associated with the network analytics. The second network node may send to the WTRU a message indicating the information associated with the network analytics.

### CROSS-REFERENCE TO RELATED APPLICATION

This application claims the benefit of U.S. provisional patent application No. 63/303,758, filed January 27, 2022, the contents of which are hereby incorporated herein by reference.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed for requesting, retrieving, and providing network analytics. A wireless transmit and receive unit (WTRU) may be configured to determine one or more artificial intelligence (AI) operation types. The AI operation types may comprise, for example, federated learning, model distribution, and/or operation split. The WTRU may be configured to send a registration message to a first network node. The registration message may indicate a capability to perform a network performance prediction and may comprise information indicating the one or more AI operation types. The information indicating the one or more AI operation types may be a service identifier which may comprise, for example, S-NSSAI (single-network slice selection assistance information).

The registration message may be received by the first network node. The first network node may be, for example, an AMF (access and mobility management function). The first network node may be configured to determine whether the WTRU may be permitted to request network performance prediction information. The first network node may determine analytic identifiers permitted to be accessed by the WTRU. The first network node may request the permitted analytic identifiers from a UDM (unified data management).

If the WTRU may be permitted to request performance prediction information, the WTRU may request analytics. The WTRU may send a packet data unit (PDU) session message that indicates a request to subscribe to one or more network analytics. The one or more network analytics may be associated with the one or more AI operation types. The WTRU may send the PDU message to a second network node.

The second network node may receive the PDU session message that indicates a request to subscribe to one or more network analytics. The PDU message may comprise information indicating the one or more AI operation types. The second network node may be, for example, a SMF (session management function). The second network node may send a subscription message to a third network node to subscribe to the one or more network analytics. The subscription message may comprise, for example, an indication of the one or more AI operation types. The third network node may be, for example, a network data analytics function (NWDAF). The second network node may receive a notification message from the third network node. The notification message may indicate information associated with the one or more network analytics. The second network node may send a message directed to the WTRU. The message may indicate the information associated with the one or more network analytics. The message may comprise analytic identifiers associated with the one or more network analytics.

Systems, methods, and instrumentalities are disclosed herein for performance monitoring and reporting to support artificial intelligence/machine learning (AI/ML) operation. AI/ML application identification may include the packet flow descriptor, which may be enhanced to enable identification of AI/ML operations. Managing AI/ML app operation using proximity communication status services may be provided. The AI/ML system may request a group of WTRUs' proximity communication status from a core network functionality (e.g., a 5G core network functionality). In such a case, the AI/ML system may include a group ID and/or WTRU ID list in the request. The AI/ML system may send the request to the core network functionality via NEF. The core network functionality may be access and mobility management function (AMF), policy control function (PCF), or direct discovery name management function (DDNMF). The core network functionality may identify the WTRU's proximity capability before triggering the WTRU to perform a proximity communication status check. If the WTRU checks a proximity communication status, the WTRU may perform a discovery procedure to discover WTRUs with a corresponding AI/ML application in proximity range. The WTRU may measure the distance associated with other WTRUs. The WTRU may check a proximity communication status by discovering the available WTRU to network relays. The WTRU may report its proximity communication status to the core network functionality via a user plane or control plane.

NWDAF-assisted system performance and predictions to support AI/ML operation management may be provided. The WTRU may be allowed according to its subscription, during a PDU, to request system performance statistics and predictions through an NF (network function) such as the session management function (SMF). The SMF may subscribe, e.g., on behalf of the WTRU, to specific Analytics and AI/ML operation types. The WTRU may provide the input parameter used for the analytics during the PDU session establishment request, e.g., within the PCO IE, or may provide the input parameters using UL NAS TRANSPORT message through the AMF. The AMF may convey the information to the NWDAF (network data analytics function) or may forward it to the SMF controlling the AI/ML PDU Session. The WTRU may provide the PDU session ID, AI/ML operation type(s), mapping of AI/ML operation types to relevant analytic IDs and the correlation ID shared by the AF endpoint counterpart through the application layer The NWDAF may use AI/ML operation type(s), mapping of AI/ML operation types to relevant analytic IDs, and the correlation ID to fetch relevant trained ML Models to generate analytics requested by the WTRU. The NWDAF may use the PDU session ID and SMF ID to notify relevant Analytics to the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of proximity communication status request and report.

FIG. 3 is a diagram illustrating an example artificial intelligence/machine learning (AI/ML) operation specific system performance statistics and predictions requested by an AF.

FIG. 4 is a diagram illustrating an example AI/ML operation specific system performance statistics and predictions requested by a WTRU.

### DETAILED DESCRIPTION

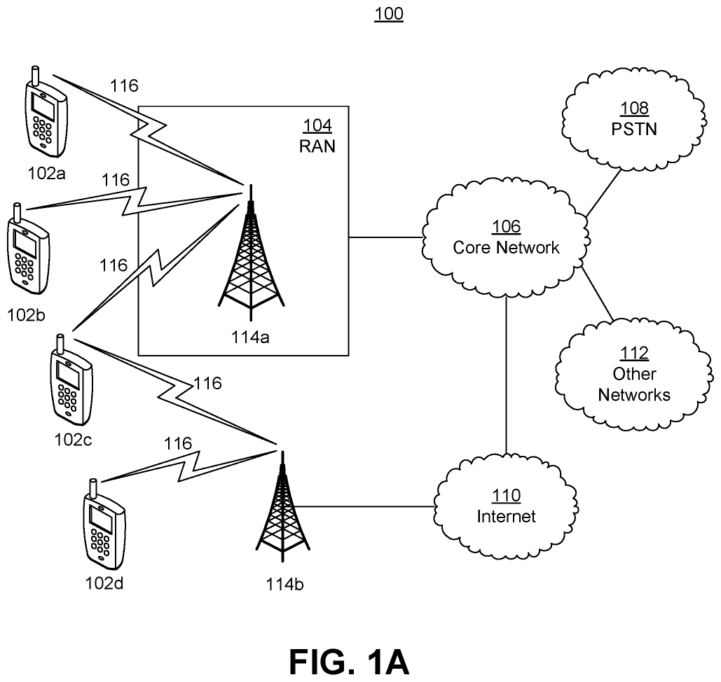

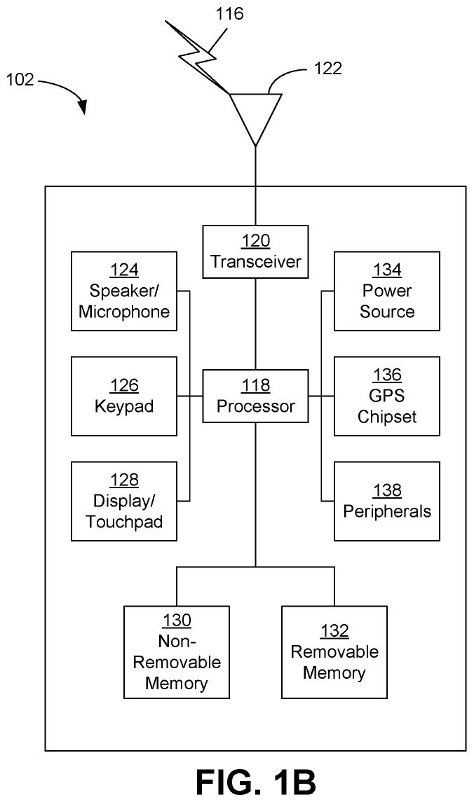

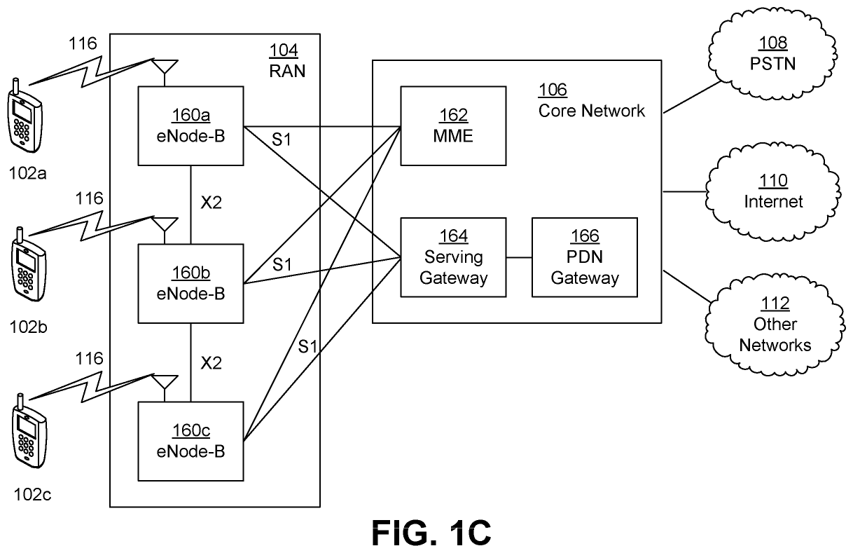

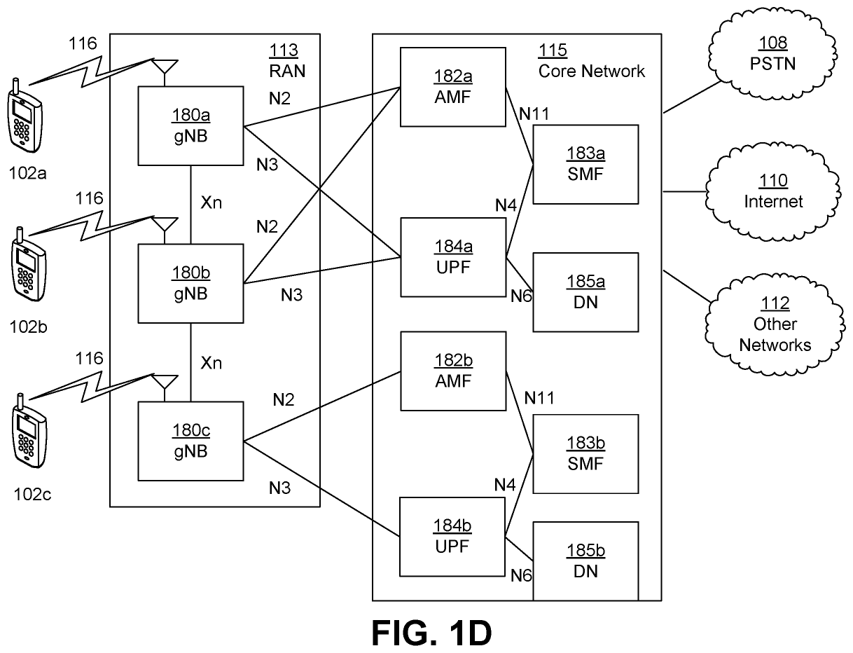

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit- switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

AI/ML (artificial intelligence/machine learning) operations may be used herein. AIML applications may drive modem vendor(s) to include dedicated AIML-specific processors. AIML-specific applications may have different characteristics than other applications running in the WTRU. AIML-specific applications may use processing and transmission of potentially large amounts of data, at specific intervals, and with stringent time windows.

To enable the application(s) to run, e.g., run optimally, features may be implemented to support monitoring of network resources to support, e.g., guarantee, the proper operation of AIML applications. The features may keep the network (e.g., applications servers) and the associated clients in the WTRU aware of the system performance to enable AIML operations to adapt to the conditions.

The AI/ML system may include one or more network functions and/or one or more application servers. The WTRU may communicate with the AI/ML system via a user plane. The user plane interface between the WTRU and AI/ML system may be an IP-based interface and may use a protocol such as hypertext transfer protocol (HTTP). The WTRU may communicate with the AI/ML system via the control plane. The control plane interface between the WTRU and AI/ML system may be a network-attached storage-based (NAS-based) interface and message(s) may be routed between the WTRU AI/ML system by the AMF.

An AI/ML endpoint may be a WTRU, network function, and/or an application server.

The terms application function and application server may be used interchangeably herein.

Given that a system may support diverse applications, instrumentalities may be provided to determine how AIML applications may differentiate from other applications to enable the system to monitor system performance affecting the applications on a per WTRU-basis. Given that there are at least three different AI/ML operations modes, instrumentalities may be provided to determine performance characteristics to be measured, monitor, and/or reported. Given that AI/ML models may be distributed across multiple endpoints including WTRUs and application functions (Afs), instrumentalities may be provided to determine how to provide system performance predictions and event notifications to both the WTRU and network and/or how to configure, monitor, and/or report predictive event(s) that may be relevant to specific AIML operations.

The system, e.g., a 5GS, may identify an AI/ML application by enhancing the packet flow description with AI/ML application information so that the system may provide analytics and predictions according to the identified traffic. The system, e.g., a 5GS, may provide proximity communication status that may be used by the AI/ML application to manage AI/ML operations (e.g., AI/ML Model Distribution). The AF and the WTRU may get system performance and predictions using the current network data analytics framework, targeting specific AI/ML operation types.

AI/ML application identification may be used herein. The system may be aware of AIML operation(s) undergoing to be able to provide them with support. The identifiers to recognize traffic may include the single-network slice selection assistance information (S-NSSAI) and data network name (DNN), which may define the network slice instance and/or the data network name considered in the app that the traffic belongs to or may be associated with.

Mechanisms to help make the application aware may exist, such as application detection filters that may be constructed using deep packet inspection. On the application server side, there may be the possibility for the ASP to provide the network with relevant information that may help in application traffic detection, e.g., through packet flow description.

The content of packet flow descriptions may be extended to support AIML Assistance Information and may allow for an awareness of the AIML application running in the system. One or more of the following attributes as shown in Table 1 may apply for the packet flow detection(s) (PFD) s:

TABLE 1

| | |
|---|---|
| 3 - tuple Protocol, server-side | |
| IP and port number | |
| Significant part of the URL to | |
| be matched | |
| A Domaine name matching | |
| criteria | |
| AIML support | Yes or no |

If AIML support (attributes):

| | |
|---|---|
| Data set type | Images / SMSs / videos / |
| | audio / |
| | Other types |
| AIML operation type | Model splitting AIML / model |
| | distribution / Federated |
| | learning |
| AIML operation task | Inference or training |
| Model size | |

Based on the AI/ML application identification, one or more of the following may apply. Relevant information that may be deducted from the PFDs that help application traffic detection may include the data set type which may be a set of images, text messages, documents, videos, audio, and/or the like. For a WTRU, during certain network conditions, traffic from two different AIML applications which may have the same data set type (e.g., images) may have the same characteristics and the same QoS treatment (e.g., 5QI, QFI and/or the like).

The indication may help avoid the need for NAS message signaling, e.g., new NAS message signaling, for possible QoS flow establishment (e.g., new QoS flow establishment) as the current QoS flow with QFI may still be used.

The information in the PFDs regarding AIML traffic, e.g., with certain attributes, may give an indication as to how long the AIML session may be active, where there may be traffic exchange, when to expect the session may be active again, and/or the like.

In terms of PFDs management, the SMF may have a caching timer per application ID where it may keep the relevant PFDs (e.g., all the relevant PFDs) until a duration of time expires (e.g., a timer expires). The SMF, e.g., if there may be an active PCC with the application ID, may reload the PFDs by pulling them from the network exposure function (NEF) (e.g., packet flow description function PFDF) and by asking the UPF to change them.

The SMF may set, e.g., intelligently set, the caching timer for a specific application ID for an AIML app based on the common AIML attributes in the corresponding PFDs such as, for example, AIML operation type, data set type, task type, and/or the like so that the timer may last long enough for the AIML traffic without reloading from the NEF again, e.g., if the SMF may expect the AIML traffic for that app to keep on running.

The caching timer may be set to last a short duration if, for example, depending on the AIML attributes, it may be detected that high traffic may be there for a short duration, which may mean that no relevant PCC rule may be active. In such case, it may be estimated that the caching timer is to be short. The SMF may remove the PFDs and may ask the UPFs to do so.

Instrumentalities for managing AI/ML application operation using proximity communication status services are disclosed herein. The instrumentalities may address the performance characteristics that may be measured, monitored, and/or reported.

A system may allow WTRUs to perform proximity communication via an interface, e.g., directly via an interface, such as a PC5 interface. The proximity communication status/capability of WTRUs may be used for AI/ML systems to manage AI/ML model distribution and/or AI/ML load balance. For example, if multiple WTRUs may be in proximity range and support proximity communication, AI/ML systems may allocate calculation load and/or calculation resources to assist the group WTRU to co-ordinate with each other.

The AI/ML system may request the WTRU's proximity communication status from a core network functionality (e.g., a 5G core network functionality). The core network functionality may trigger the WTRU to perform a proximity communication status check, e.g., to determine WTRUs in proximity communication range and the distance of a WTRU (e.g., each WTRU) and thereby check the proximity communication radio channel's quality. The WTRU may report its proximity communication status and/or proximity communication radio channel's quality to the core network functionality. The core network functionality may report the WTRU's proximity communication status and/or proximity communication radio channel's quality to the AI/ML system.

The AI/ML system may request a group of WTRUs' proximity communication status from the core network functionality. The AI/ML system may include a group ID and/or WTRU ID list in the request.

The AI/ML system may include an indication of AI/ML operation type in the WTRU's proximity communication status request. The core network functionality may trigger the WTRU to perform a proximity communication status check based on the AI/ML operation type, (e.g., details of AI/ML operation type may be described herein). For example, the core network functionality may indicate which kind of ProSe discovery may be used for proximity communication status check (e.g., model A, model B, or group discovery).

The AI/ML system may send a request to the core network functionality via an NEF.

The core network functionality, e.g., 5G core network functionality, may be an AMF, PCF or DDNMF.

The core network functionality may identify the WTRU's proximity capability before triggering the WTRU to perform a proximity communication status check. The core network functionality may check whether the WTRU may be authorized for the AI/ML application and/or AL/ML operation type.

If the WTRU checks a proximity communication status, the WTRU may perform a discovery procedure to discover WTRUs with a corresponding AI/ML application in proximity range. The WTRU may measure the distance between the WTRU and other WTRUs.

The WTRU may check a proximity communication status by discovering the available WTRU to network relays.

The WTRU may report its proximity communication status to the core network functionality via a user plane or control plane.

A WTRU's proximity communication status request (e.g., all WTRUs' proximity communication status requests) may indicate the report mode (e.g., indicate when and how frequently to report or in which conditions the WTRU may report).

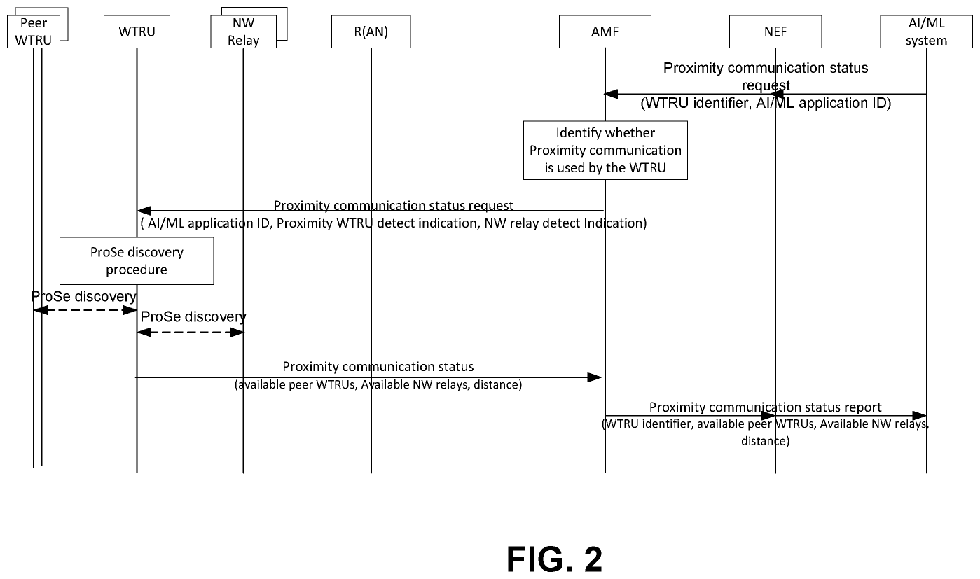

FIG. 2 shows an example of a proximity communication status request and report. The AI/ML system(s) may send a proximity communication status request to an AMF via NEF. The proximity communication status request may include a WTRU's IDs, group ID, and/or an AI/ML application ID. The AMF may identify whether the WTRUs (e.g., requested by AI/ML) support and/or enable proximity communication. The AMF may send a proximity communication status request to available WTRUs. The proximity communication status request may include an AI/ML application ID. The WTRU may trigger a discovery procedure to discover WTRUs supporting the AI/ML application ID. The WTRU may report discovered peer WTRUs, distance, and/or the like to the AMF. The AMF may forward the reported information to the AI/ML system. The report may be sent via the NEF. The AMF may report the proximity communication status of the WTRU to the AI/ML system.

Instrumentalities for NWDAF-assisted system performance and predictions are disclosed herein. The instrumentalities may address how to provide system performance prediction event notification to a WTRU and network.

System support for event exposure may be for authorized third parties. For example, support may be provided for monitoring of specific events for a WTRU in the system, which may be provided via NEF and include monitoring capability, provisioning capability, policy/charging capability, and/or analytics reporting capability.

Network functions (NFs) may subscribe to WTRU-related event notifications (e.g., analytics information generated by the system). The event notification service may be available for neither access networks nor WTRUs.

To provide system performance prediction event notification to an authorized external party, which may be an AF, a mechanism may rely on NWDAF to generate the predictions.

System performance predictions and/or system performance statistics may be provided to the WTRU and the AF using a mechanism and/or procedure (e.g., an existing 5GS mechanism and/or procedure). Enhancements to system exposure procedures to provide systems performance statistics and prediction for AFs as well as WTRU counterpart procedures may be described herein.

Extensions for external party (e.g., third-party) reporting are provided. The AI/ML application function may use the system to support at least three types of operation including, for example, the following: AI/ML operation splitting between AI/ML endpoints; AI/ML model/data distribution and/or sharing over system; and/or distributed/federated learning (FL) over a system. AI/ML operation splitting between AI/ML endpoints may be supported. The operation may be split according to specific tasks and environment such that computation intensive components may be executed at the network side, while privacy sensitive components may be executed at the WTRU. AI/ML model/data distribution and/or sharing over system may be supported. An online model distribution to enable adaptation to tasks and environments variations without requiring model pre-loading may be provided. Distributed/federated Learning (FL) over the system may be supported. The AI/ML AF may train a global model by aggregating local models partially trained by devices to be part of a federated learning group.

Requesting system performance analytics and/or predictions through NWDAF are provided. To obtain system performance predictions from the system, the AF may subscribe to analytics or request analytics using NWDAF services and it may provide analytics filter information indicating the specific AI/ML operation type the analytics apply to.

When registering to the NRF, a NWDAF comprising a model training logical function (MTLF) may provide the AI/ML operations for which analytics and associated trained ML models may apply.

The NWDAF (e.g., the AnLF) may use the AI/ML operation type provided by the AF to discover and/or select applicable MTLF supporting trained ML Models to produce analytics that may be applicable to the type of AI/ML operation.

The AF may request different analytics exposure procedures to obtain system performance monitoring information and system behavior predictions, for example, based on the AI/ML operation it supports. These analytics may include DN performance analytics, which may be a procedure used for edge applications and it may be used by an AF (e.g., any AF) to obtain information relevant to AI/ML operations. The AF may provide, e.g., in addition to the inputs described herein, the following information: analytics filter information to specify the AI/ML operations the analytics apply to. Table 2 shows how the AF may provide filtering information to derive relevant analytics for an AI/ML operation.

TABLE 2

| Information | Description |
|---|---|
| Application ID | The identification of the application(s) for which the |
| (AI/ML) | analytics information is subscribed or requested. |
| S-NSSAI | Identifies the Network Slice for which analytics |
| | information is subscribed or requested. |
| NSI ID(s) | Identifies the Network Slice instance(s) for which |
| | analytics information is subscribed or requested. |
| Area of Interest | Identifies the Area (i.e., set of TAIs (tracking area |
| | identifier(s)) for which the analytics information is |
| | subscribed or requested. |
| UPF anchor identity | Identifies the UPF where a WTRU has an |
| | associated PDU session. |
| DNN | DNN to access the application. |
| DNAI | Identifier of a user plane access to one or more |
| | DN(s) where applications are deployed. |
| Application Server | List of IP address(s)/FQDN(s) of the Application |
| Address(es) | Server(s) that a WTRU, group of WTRUs, or ‘any |
| | WTRU’ has a communication session with for |
| | which DN Performance Analytic information is |
| | requested. |
| List of analytics | List of analytics subsets that are requested as |
| subsets | described herein |
| AI/ML operation | List of AI/ML operations supported by this Analytic |
| type | ID. Acceptable values: Model Distribution, |
| | Operation Split, Federated Learning. NOTE: The |
| | operation type could also be expressed as a |
| | specific Application ID. |

Table 2 shows an example of analytics filter information related to DN performance analytics for AI/ML operations or a combination of them (e.g., AI/ML operation split and AI/ML federated learning, or AI/ML model distribution and AI/ML federated learning). If the AI/ML operation type is federated learning, the AF may provide the federating learning group ID identifying WTRUs (e.g., all WTRUs) within a group and the time windows when the statistics and/or predictions apply. If the AI/ML operation type is model distribution, the AF may provide a list of AF Service Identifier for which the AF uses performance predictions and/or analytics. The NWDAF may use the information to derive performance predictions and/or analytics (e.g., maximum packet delay and/or maximum traffic rate between two endpoints of the distributed model). If the AI/ML operation is a combination of any of them, the NWDAF may use the information to derive performance prediction and/or analytics (e.g., application specific congestion at a location and during a specific time window, affecting AI/ML federating learning and/or AI/ML model distribution).

The analytics may include user data congestion analytics. The AF may use predictions generated by the analytics to enhance model distribution operations, for example, based on environmental change (e.g., data volume changes at a location and/or excessive signaling at a location and/or Network Slice). The AF may use the information to derive the impact on other applications due to a specific AI/ML operation. The AF may provide, e.g., in addition to the inputs described herein, the following information: if the AI/ML operation type is federated learning, model distribution, or AI/ML operation split. If the AI/ML operation type is Federated Learning, the time window when the AI/ML operation applies may be included in the information provided in the analytics.

Procedures to request system performance statistics and/or predictions for specific AI/ML operations may be provided.

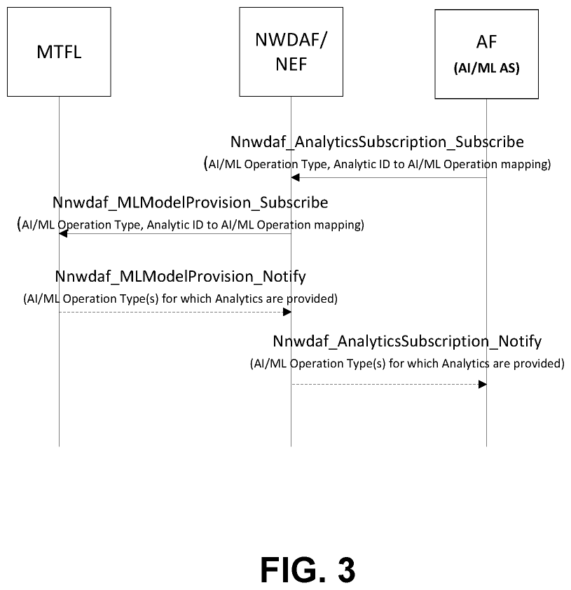

FIG. 3 shows example processing for AI/ML operation specific system performance statistics and predictions requested by AF. The AF may subscribe, e.g., directly subscribe, to analytics information or via NEF by invoking the Nnef_AnalyticsExposure_Subscribe service operation. The AF may provide AI/ML Operation Type (e.g., model distribution, operation split, federated learning, or a combination of them). The AF may provide a mapping of what analytic IDs correspond to what AI/ML Operation Type.

The NWDAF may subscribe to trained ML model(s) associated with the analytics and AI/ML operations provided by the AF.

If the MTLF service consumer subscribes to trained ML model(s) (e.g., a set of trained ML models) associated with analytics ID(s) (e.g., a set of analytics IDs) and AI/ML operation types, the MTLF may notify the MTLF service consumer with the trained ML model information (e.g., comprising a set of file address of the trained ML model).

If NWDAF service consumer is subscribed to analytics information, the NWDAF may notify the NWDAF service consumer with the analytics information by invoking Nnwdaf_AnalyticsSubscription_Notify service operation, for example, based on the request from the NWDAF service consumer (e.g., AI/ML operation type). If a service consumer provides a specific AI/ML operation type (e.g., AI/ML Model Distribution), the NWDAF may generate system performance and/or predictions to characterize the traffic for an application during a time interval and at a specific location. The AF may request on demand system performance statistics and/or predictions using an analytics request service operation and providing relevant AI/ML operation type(s).

Capabilities (e.g., new capabilities) to support WTRU system performance and predictions requests may be provided. The WTRU may be capable and/or may be configured to receive system performance statistics and/or prediction information. In such a case, the WTRU may indicate its capability during the registration implementation by including an IE (Information Element) (e.g., new IE such as a system performance monitoring capability). An SST (e.g., a new SST such as AI/ML operations) may be defined to carry AI/ML operations. The slice differentiator may be used to signal, e.g., send, the AI/ML operation type running on the network slice.

The Operator may enable WTRU system performance monitoring permission as part of the WTRU's subscription record stored in the UDM. During the registration, the AMF may check whether the WTRU may be allowed to request system performance monitoring and may fetch the allowed analytic IDs and possible AI/ML operation types from the UDM.

If the WTRU is allowed according to its subscription, during a PDU session establishment process, the WTRU may request system performance statistics and/or predictions through an NF such as the SMF.

The SMF may subscribe, e.g., on behalf of the WTRU, to specific analytics and AI/ML operation types. The WTRU may provide the input parameter used for the analytics during the PDU Session establishment request, e.g., within the PCO IE, or it may provide the input parameters using an UL NAS TRANSPORT message, through the AMF. The AMF may convey the information to the NWDAF or may forward it to the SMF controlling the AI/ML PDU Session.

The WTRU may provide, e.g., in addition to the parameters described herein, the PDU session ID, AI/ML operation type(s), mapping of AI/ML operation types to relevant analytic IDs, and/or the correlation ID shared by the AF endpoint counterpart, through the application layer. During the PDU session establishment implementation, the SMF may provide in the PDU Session establishment accept message, e.g., within the PCO IE, the relevant analytics IDs that may be supported by the selected NWDAF (e.g., the one available in the AI/ML network slice).

The NWDAF may use AI/ML operation type(s), mapping of AI/ML operation types to relevant analytic IDs, and the correlation ID to fetch relevant trained ML models to generate analytics requested by the WTRU.

The NWDAF may use the PDU session ID and SMF ID to notify relevant analytics to the WTRU.

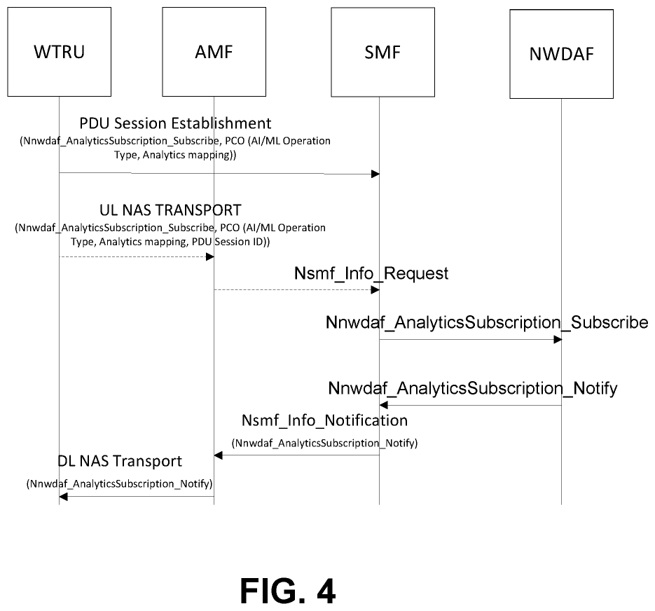

FIG. 4 AI/ML shows example processing for operation specific system performance statistics and predictions requested by a WTRU. The WTRU may subscribe to analytics information using a PDU session establishment or PDU session modification implementation and may provide input parameters e.g., within the PCO IE, including AI/ML operation type (e.g., model distribution, operation split, federated learning). The WTRU may provide a mapping of what analytic IDs correspond to what AI/ML operation type. The WTRU may use a UL NAS TRANSPORT message to convey inputs, indicating the PDU Session ID, S-NSSAI and DNN the request may be intended for. The AMF may use the information to select the correct SMF. The AMF may use a Nsmf_info_Request Service operation to relay the request to the selected SMF, as described herein.

The SMF may provide, e.g., within the PCO IE, the list of supported analytics ID(s) in the NWDAF(s) associated with the AI/ML operation slice (e.g., available analytics ID(s).

The SMF may subscribe, e.g., on behalf of the WTRU, to analytics associated with specific AI/ML operation type(s) provided by the WTRU.

The NWDAF may notify the NWDAF service consumer (e.g., the SMF acting on behave of the WTRU) with the analytics information by invoking Nnwdaf_AnalyticsSubscription_Notify service operation, for example, based on the request from the NWDAF service consumer (e.g., specific AI/ML operation type).

The SMF may use a Nsmf_info_Notification Service operation to relay the Nnwdaf_AnalyticsSubscription_Notify message to the WTRU via the AMF.

The AMF may use a DL NAS TRANSPORT message to relay the Nnwdaf_AnalyticsSubscription_Notify message carrying the system performance statistics and Predictions requested by the WTRU. The message may carry an endpoint address where the WTRU may fetch the system performance statistics and predictions, via the user plane.

Systems, methods, and instrumentalities have been disclosed for requesting, retrieving, and providing network analytics. A WTRU may be configured to send a registration message to a first network node. The registration message may indicate a capability to perform a network performance prediction and may comprise information indicating one or more AI operation types. The registration message may be received by a first network node that may be configured to determine whether the WTRU may be permitted to request network performance prediction information. If the WTRU is permitted to request performance prediction information, the WTRU may send a packet data unit (PDU) session message that indicates a request to subscribe to one or more network analytics associated with the one or more AI operation types. A second network node may receive the PDU session message and may send a subscription message to a third network node to subscribe to the one or more network analytics. The subscription message may comprise, for example, an indication of the one or more AI operation types. The second network node may receive a notification message that indicates information associated with the one or more network analytics. The second network node may send to the WTRU a message indicating the information associated with the one or more network analytics. The message may comprise analytic identifiers associated with the one or more network analytics.

Although features and elements described herein are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random-access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-29. (canceled)

30. A wireless transmit receive unit (WTRU) comprising:
a processor configured to:
receive system performance statistics;
send a NAS message indicating a request for network analytics, the NAS message comprising one or more analytic identifiers, a correlation identifier, and a slice service type (SST); and
receive an analytics message from a network node, wherein the analytics message indicates one or more network analytics.

31. The WTRU of claim 30,
wherein the SST corresponds to artificial intelligence (AI) operation types and the NAS message further comprises a mapping between the AI operation types and one or more analytic identifiers.

32. The WTRU of claim 31,
wherein the AI operation types comprise one or more of model distribution, operation split, or federated learning.

33. The WTRU of claim 30,
wherein the NAS message comprises a session establishment message.

34. The WTRU of claim 30,
where the NAS message comprises a NAS transport message.

35. The WTRU of claim 30,
wherein the processor configured to receive the analytics message from the network node is further configured to receive performance statistics and predictions.

36. The WTRU of claim 30,
wherein the processor configured to receive the analytics message from the network node is further configured to receive a network address associated with accessing performance statistics and predictions.

37. The WTRU of claim 30,
wherein the processor configured to receive the analytics message from the network node is further configured to receive a NAS transport message.

38. A method comprising:
receiving system performance statistics;
sending a NAS message indicating a request for network analytics, the NAS message comprising one or more analytic identifiers, a correlation identifier, and a slice service type (SST); and
receive an analytics message from a network node, wherein the analytics message indicates one or more network analytics.

39. The method of claim 38,
wherein the SST corresponds to artificial intelligence (AI) operation types and the NAS message further comprises a mapping between the AI operation types and one or more analytic identifiers.

40. The method of claim 39,
wherein the AI operation types comprise one or more of model distribution, operation split, or federated learning.

41. The method of claim 38,
wherein the NAS message comprises a session establishment message.

42. The method of claim 38,
where the NAS message comprises a NAS transport message.

43. The method of claim 38,
wherein receiving the analytics message from the network node further comprises receiving performance statistics and predictions.

44. The method of claim 38,
wherein receiving the analytics message from the network node further comprises receiving a network address associated with accessing performance statistics and predictions.

45. The method of claim 38,
wherein receiving the analytics message from the network node further comprises receiving a NAS transport message.

46. A wireless transmit receive unit (WTRU) comprising:
a processor configured to:
send a NAS message indicating a request for network analytics to a session management function (SMF), the NAS message comprising one or more analytic identifiers, a correlation identifier, and a slice service type (SST); and
receive from an access and mobility management function (AMF) an analytics message from a network node, wherein the analytics message indicates one or more network analytics.

47. The WTRU of claim 46,
wherein the SST corresponds to artificial intelligence (AI) operation types and the NAS message further comprises a mapping between the AI operation types and one or more analytic identifiers.

48. The WTRU of claim 47,
wherein the AI operation types comprise one or more of model distribution, operation split, or federated learning.

49. The WTRU of claim 38,
wherein the NAS message comprises one of a session establishment message or a NAS transport message.
